(19) United States
(12) Patent Application Publication
(10) Pub. No.: US 2013/0235783 A1
(43) Pub. Date: Sep. 12, 2013

(54) EVOLVED MULTIMEDIA BROADCAST MULTICAST SERVICE CAPACITY ENHANCEMENTS

(71) Applicant: QUALCOMM INCORPORATED, San Diego, CA (US)

(72) Inventors: Michael Mao WANG, San Diego, CA (US); Gordon Kent WALKER, Poway, CA (US); Gang BAO, San Diego, CA (US); Jun WANG, San Diego, CA (US); Xiaoxia ZHANG, San Diego, CA (US)

(73) Assignee: QUALCOMM Incorporated, San Diego, CA (US)

(21) Appl. No.: 13/766,719

(22) Filed: Feb. 13, 2013

Related U.S. Application Data
(60) Provisional application No. 61/609,098, filed on Mar. 9, 2012.

(51) Int. Cl. H04W 4/06

(52) U.S. Cl. CPC H04W 4/06
USPC 370/312

(57) ABSTRACT

A method, an apparatus, and a computer program product for wireless communication are provided in which a first cell receives a configuration identifying a plurality of transmission layers in a multi-layer spatial multiplexing scheme of a Multi-Media Broadcast over a Single Frequency Network (MBSFN). The configuration may identify resource block allocations to transmission layers, seed values for pattern generation, and timing information used to allocate resource blocks to transmission layers. The first cell transmits a first set of resource blocks during a first period of time using a first transmission layer to one or more user equipments (UE) located in the MBSFN. Another cell located in the MBSFN may concurrently transmit a second set of resource blocks to the UE in a second transmission.

### CROSS-REFERENCE TO RELATED APPLICATION(S)

This application claims the benefit of U.S. Provisional Application Ser. No. 61/609,098 entitled “Evolved Multimedia Broadcast Multicast Service Capacity Enhancements” and filed on Mar. 9, 2012, which is expressly incorporated by reference herein in its entirety.

### BACKGROUND

1. Field

The present disclosure relates generally to communication systems, and more particularly, to wireless communication systems with evolved multimedia broadcast multicast service.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a first cell receives a configuration identifying a plurality of transmission layers in a multi-layer spatial multiplexing scheme of a Multi-Media Broadcast over a Single Frequency Network (MBSFN). The configuration may identify resource block allocations to transmission layers, seed values for pattern generation, and timing information used for resource block allocation to transmission layers. In an aspect of the disclosure, the first cell transmits a first set of resource blocks during a first period of time using a first transmission layer to one or more user equipments (UE) located in the MBSFN. Another cell located in the MBSFN may concurrently transmit a second set of resource blocks to the UE in a second transmission layer.

In an aspect of the disclosure, the first and second sets of resource blocks may comprise the same resource blocks. In some embodiments, a plurality of cells transmit the first set of resource blocks to the UE in the first transmission layer during the first period of time. Signals from the plurality of cells may arrive at the UE at different times. A cyclic prefix may be defined for the MBSFN that has a duration selected to enable the UE to coherently combine the signals that arrive from the plurality of cells.

In an aspect of the disclosure, the first cell transmits the first set of resource blocks in the first transmission layer in accordance with an assignment of the first cell to the first transmission layer, the assignment being provided by the configuration. The first transmission layer may be assigned to the first cell based on a physical cell identifier (PCI) associated with the first cell and/or the first transmission layer may be assigned to the first cell based on an MBSFN area identifier.

In an aspect of the disclosure, the first cell may be reassigned to the second transmission layer during a second period of time and the first cell may transmit resource blocks only in its currently assigned transmission layer. Reassignment of the first cell to the second transmission layer may be initiated based on a function of time.

In an aspect of the disclosure, the first set of resource blocks is different from the second set of resource blocks. The first cell also transmits the second set of resource blocks to the UE in the second transmission layer during the first period of time. In some embodiments, the configuration defines an allocation of resource blocks or groups of resource blocks to each of the first and second sets of resource blocks. In some embodiments, the first cell transmits the first set of resource blocks in the first transmission layer and the second set of resource blocks in the second transmission layer based on a layer pattern provided by the configuration. In some embodiments, the first cell uses a combination of transmission layers and sets of resource blocks during a second period of time that is different from the combination of transmission layers and sets of resource blocks used during the first period of time.

In an aspect of the disclosure, during the first period of time another cell transmits at least one resource block to the UE in the first transmission layer that is not also transmitted by the first cell in the first transmission layer during the first period of time. The first cell transmits at least one resource block in the first transmission layer that is also transmitted by the another cell in the first transmission layer during the first period of time. The first set of resource blocks may include a minimum number of adjacent resource blocks.

In an aspect of the disclosure, transmitting a first set of resource blocks includes randomly selecting one or more resource blocks to be transmitted in the first transmission layer and one or more resource blocks to be transmitted in the second transmission layer. The first cell may transmit a selection of resource blocks in the first and second transmission layers during a second period of time that is different than the selection of resource blocks that is transmitted in the first and second transmission layers during the first period of time.

In an aspect of the disclosure, resource blocks are allocated to the first and second sets of resource blocks and the first and second sets of resource blocks are assigned to the first and second transmission layers by an operation and maintenance (OAM) provider of the MBSFN.

In an aspect of the disclosure, resource blocks are allocated to the first and second sets of resource blocks and the first and second sets of resource blocks are assigned to the first and second transmission layers by a Multi-Cell/Multicast Coordination Entity (MCE) service provider of the MBSFN.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service channel configuration in a Multicast Broadcast Single Frequency Network.

FIG. 7B is a diagram illustrating a format of a Multicast Channel Scheduling Information Media Access Control control element.

FIG. 8 illustrates an access network that employs eMBMS.

FIG. 9 illustrates resource block mapping to transmission layers.

FIG. 10 is a flow chart of a method of wireless communication.

FIG. 11 is a conceptual data flow diagram illustrating the data flow between different modules/means/components in an exemplary apparatus.

FIG. 12 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray™ disc where disks usually reproduce data magnetically, while discs reproduce data optically with lasers. Combinations of the above should also be included within the scope of computer-readable media.

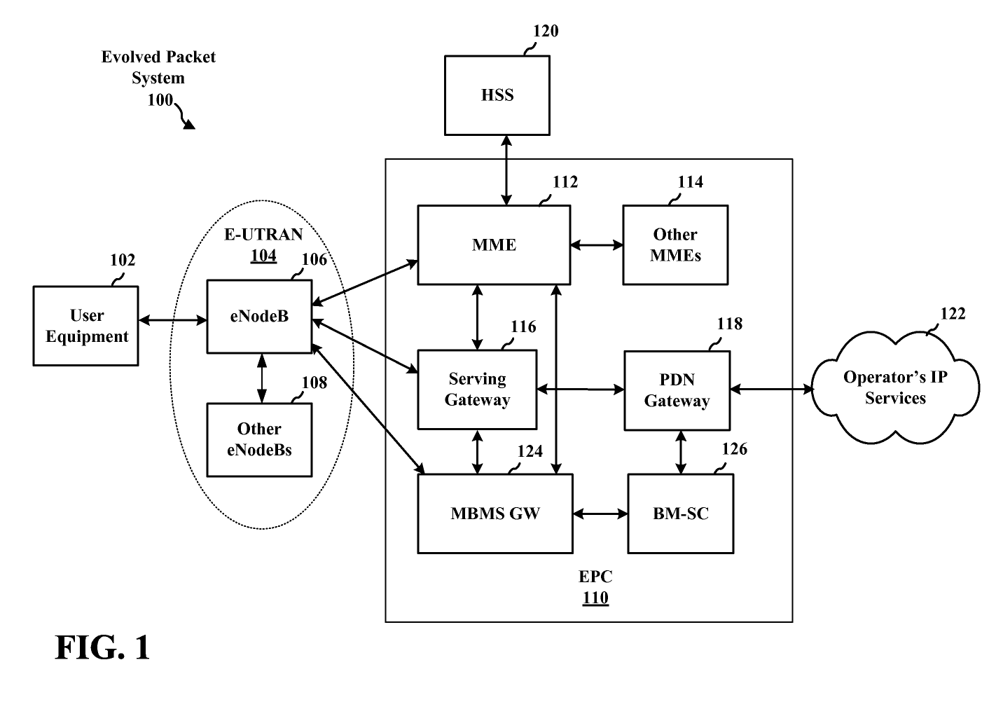

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 includes a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

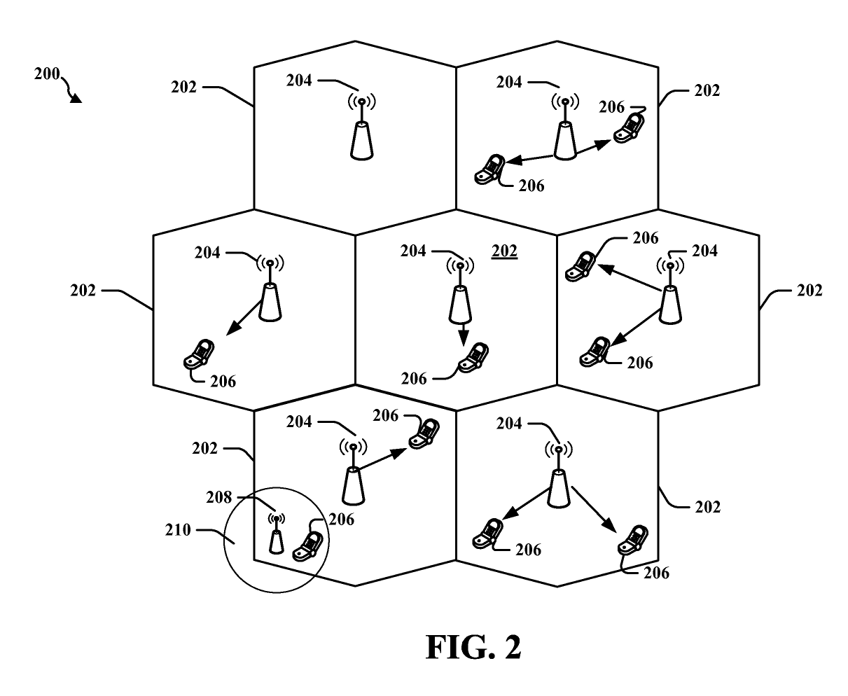

FIG. 2 is a diagram illustrating an example of an access network 200 in an LTE network architecture. In this example, the access network 200 is divided into a number of cellular regions (cells) 202. In 3GPP, the term “cell” can refer to the smallest coverage area of an eNB and/or an eNB subsystem serving this coverage area, depending on the context in which the term is used. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. Although each eNB 204 in FIG. 2 is illustrated within a single cell 202, an eNB 204 may support one or multiple (e.g., three) cells. Accordingly, the terms “eNB”, “base station”, and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

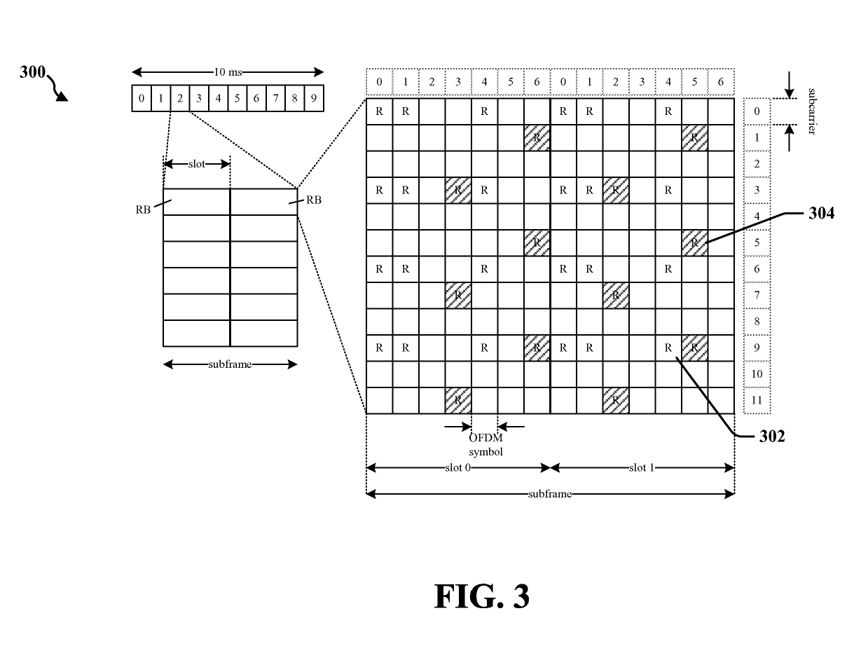

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

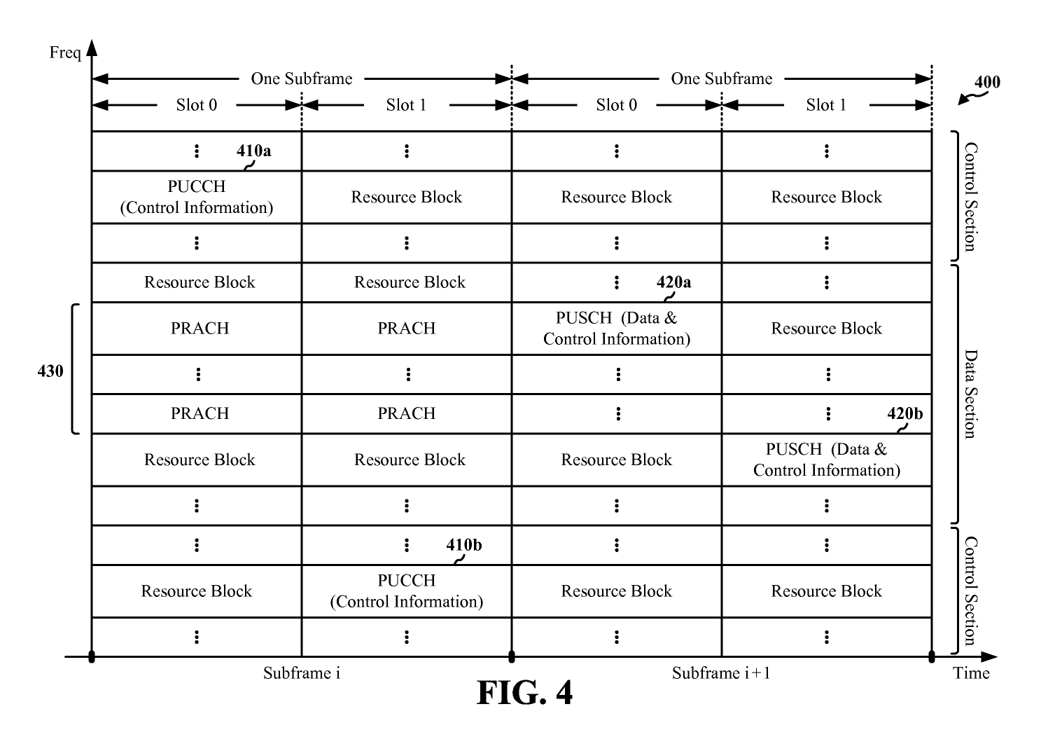

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

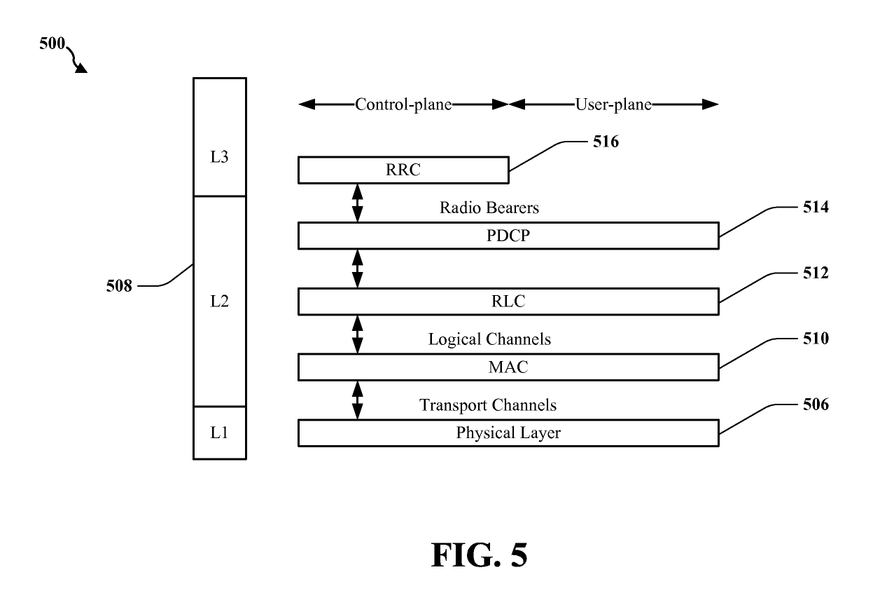

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

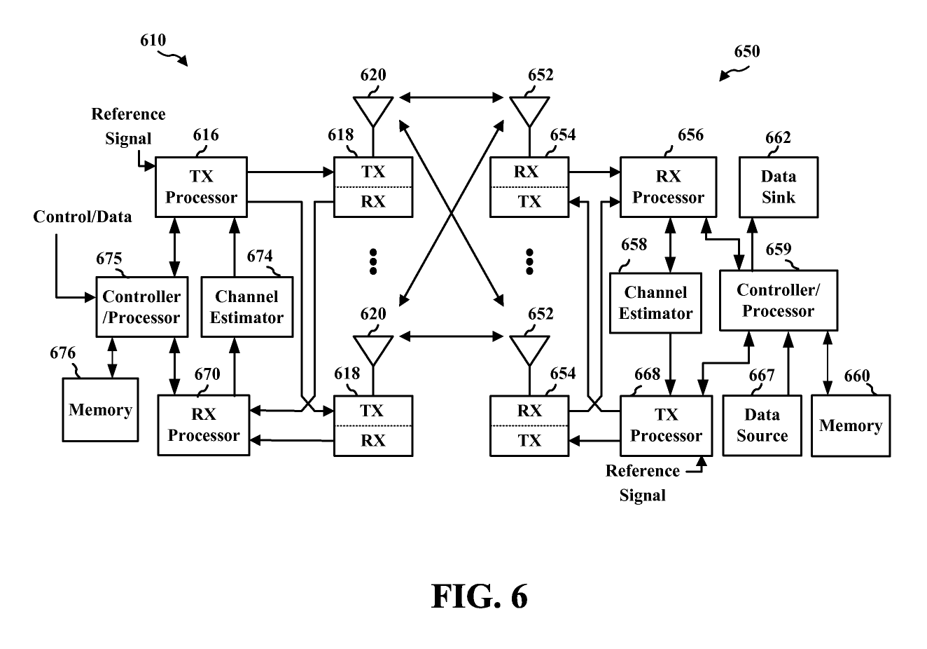

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

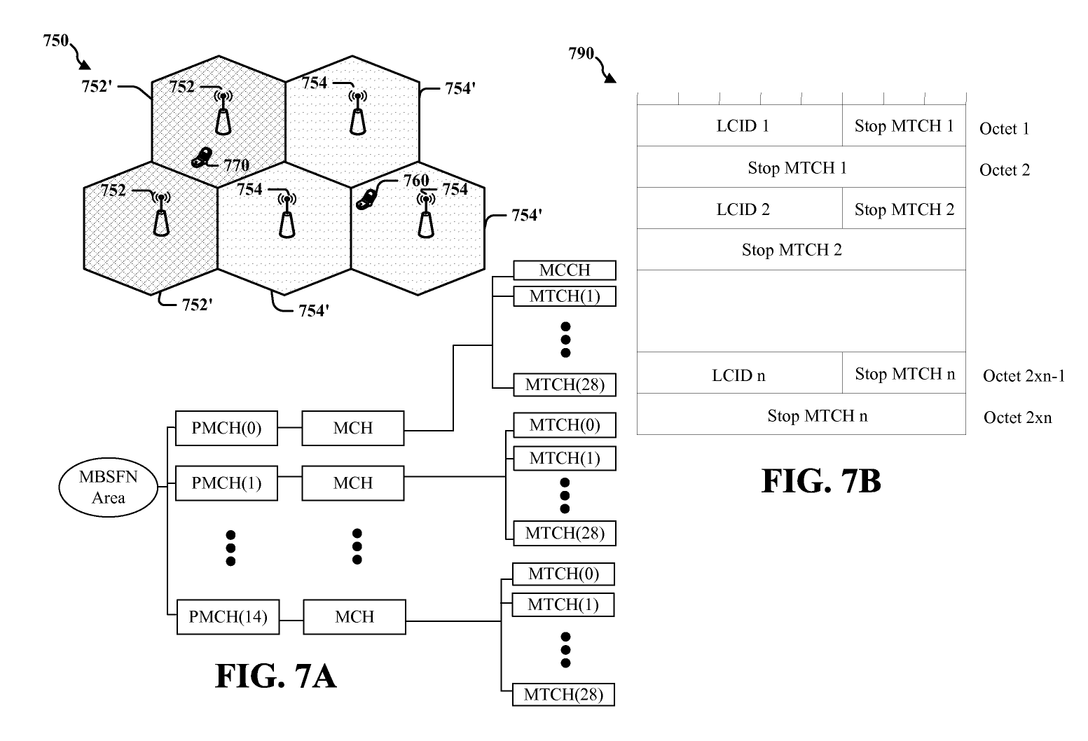

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. In a first step, the UE acquires a system information block (SIB) (SIB13). In a second step, based on the SIB, the UE acquires an MBSFN Area Configuration message on an MCCH. In a third step, based on the MBSFN Area Configuration message, the UE acquires an MCH scheduling information (MSI) MAC control element. The SIB, e.g., SB13 include (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There may be one MBSFN Area Configuration message for each MBSFN area. The MBSFN Area Configuration message include (1) a temporary mobile group identity (TMGI) and an optional session identifier of each MTCH identified by a logical channel identifier within the PMCH, (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There is one MSI per PMCH per MBSFN area.

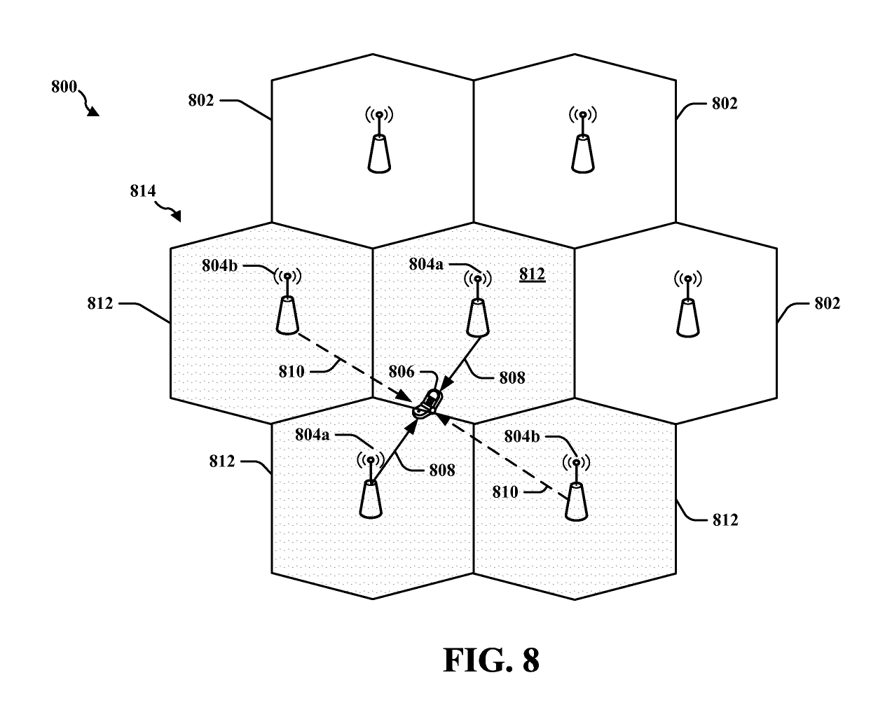

FIG. 8 is a diagram illustrating an access network 800 that employs eMBMS. In this example, the access network 800 is divided into a number of cells 802 and 812, where cells 812 belong to an MBSFN. In the cells 812 of an MBSFN area 814, an eNB 804a or 804b or group of eNBs 804a or 804b may transmit a data stream using one or more transmission layers (represented by lines 808 and 810). Although each eNB 804a, 804b in FIG. 8 is illustrated within a single MBSFN cell 812, an eNB may support one or multiple (e.g., three) cells. Accordingly, the terms “eNB” and “cell” may be used interchangeably herein. In other words, when an eNB is described herein as transmitting a signal, such transmission may encompass—in some cases—a transmission of the same signal by all cells supported by that eNB, and in other cases, a transmission by one or more, but not necessarily all, of the cells supported by that eNB. Likewise, when a cell is described herein as transmitting a signal, such transmission may encompass—in some cases—a transmission of the same signal by all cells supported by an eNB, and in other cases, a transmission by one or more, but not necessarily all, of the cells supported by that eNB. The eNBs 804a and 804b may have multiple antennas and may employ MIMO technology to exploit the spatial domain to obtain signal diversity and to support spatial multiplexing. Signal diversity may be obtained by transmitting a data stream in identical signals emitted from a plurality of transmit antennas. Intra-site MIMO can be used in a particular cell 812 when both eNB 804a and the UE 806 are equipped with a plurality of antennas. In inter-site MIMO, spatial diversity may also be obtained by virtue of the geographical separation of eNBs 804a and 804b. Signals from eNBs 804a and 804b may be combined at the UE 806 to benefit from multiplexing gain. Aspects of this disclosure will be described with respect to the inter-site MIMO example, but certain underlying principles relate equally to intra-site MIMO.

Certain embodiments employ spatial multiplexing to split a signal, such as a high data rate signal, into multiple lower rate data streams. The lower rate data streams may then be transmitted with different spatial coding in different transmission layers using the same frequency channel. In FIG. 8, different transmission layers are depicted as solid line 808 and dotted line 810, respectively. In the example, two transmission layers 808 and 810 are available when the UE 806 has at least two receive antennas. Some embodiments use more than two transmission layers and the spatial coding may take advantage of the multiple antennas employed by eNBs 804a and 804b. UE 806 may recover the data streams when the signals arrive at the antenna array of the UE 806 with sufficiently different spatial signatures. A spatial signature may characterize certain aspects of a signal arriving at an antenna array at a certain location, such as the direction of arrival of the signal, etc.

In some embodiments, all eNBs 804a and 804b in the MBSFN area 814 transmit the same eMBMS control information and data stream in a synchronous manner, whereby the eNBs 804a and 804b transmit the same signal at the same time. In some embodiments, each eNB 804a or 804b within the MBSFN area 814 may be configured to use one or more transmission layers 808 and 810 to carry the data stream. In one example, each eNB 804a or 804b may be assigned to a single transmission layer 808 or 810 and may transmit the entire data stream over the assigned transmission layer 808 or 810. In another example, eNB 804a and 804b may spatially multiplex the data stream, transmitting portions of the data stream in two or more transmission layers 808 and 810. For example, the data stream may be divided by allocating different sets of resource blocks in the data stream to sets of resource blocks assigned to two or more transmission layers 808 and 810.

In some embodiments, one or more eNBs 804a transmit a data stream in one transmission layer 808 while at least one other eNB 804b transmits a different data stream concurrently in another transmission layer 810. The transmission of different waveforms in different layers by different cells, available through MIMO, is distinct over conventional eMBMS where each cell transmits the same waveform. The assignment of a transmission layer 808 or 810 to a cell 812 may be based on a configuration provided to the eNBs 804a and 804b. In one example, the assignment of transmission layer 808 or 810 may be based on the PCI assigned to each eNB 804a or 804b during network planning. For example, eNBs with an even PCI may be assigned to one transmission layer while eNBs with an odd PCI may be assigned to another transmission layer.

The assignment of a transmission layer 808 or 810 may change after a period of time, or after a reconfiguration of eNBs 804a and 804b. Changes in assignment may be periodic and the frequency of change may be provided to the eNBs through a configuration provided by a management function of the MBSFN. In some embodiments, eNBs 804a and 804b may be reassigned between transmission layers 808 and 810 according to a function of time, typically defined by a configuration. The assignment of transmission layers 808 and 810 to eNBs 804a and 804b may also be based on an MBSFN area identifier or some combination of PCI, a specified time, a function of time, and MBSFN area identifier.

In some embodiments, the assignment of transmission layers 808 and 810 may be controlled or configured by an OAM service of the network or MBSFN, by an MCE service of the network or MBSFN, or by some other management or control function. The OAM may provide backhaul configuration services related to the MBSFN in an LTE system. An MCE may be provided in an MBSFN to allocate radio resources used by eNBs 804a and 804b for eMBMS transmissions in the MBSFN area. An OAM or MCE may implement changes by providing updated configuration information to the eNBs 804a and 804b that causes the eNBs 804a and 804b to select one or more transmission layers 808 and 810 for transmitting the data stream.

In some embodiments, spatial multiplexing is used in an MBSFN to transmit data streams using two or more transmission layers 808 and 810, whereby resource blocks are grouped into a plurality of sets or groups of resource blocks. Each group of resource blocks may comprise a plurality of consecutive resource blocks. For example, 25 resource blocks may be assigned to 5 groups where each group comprises 5 consecutive resource blocks. In some embodiments, the 25 resource blocks may be assigned to a different number of groups, each group having a minimum number of consecutive resource blocks. For example, 5 groups of four consecutive resource blocks and one group of five resource blocks. In certain embodiments, a common grouping structure for resource blocks is shared by all eNBs 804a and 804b.

Each group of resource blocks may be assigned to at least one transmission layer 808 or 810 by each eNB 804a and 804b. For example, an eNB 804a or 804b may randomly select one or more resource block groups for transmission in a first transmission layer 808 or 810 and may additionally select one or more groups of resource for transmission in a second transmission layer 810 or 808. Each eNB 804a and 804b transmits on all of the resource block groups. In one example, the eNB 804a or 804b may use a random seed value to select the resource block groups for transmission in each available transmission layer 808 and 810. The random seed may be generated using, for example, one or more of a PCI, an MBSFN area ID, and a time value.

The assignment of transmission layers 808 and 810 and the allocation of resource block groups among transmission layers 808 and 810 may be defined in a layer pattern. In some embodiments different random layer patterns are used by an eNB 804a and 804b to determine which resource block groups to transmit in transmission layers 808 and 810. The randomness of the layer pattern may be limited by policies that restrict allocation of resource blocks between transmission layers 808 and 810. In one example, the layer pattern policies may limit the granularity of the sets of resource blocks, where granularity may describe a minimum number of resource blocks allocated to a set of resource blocks, and/or the minimum number of adjacent resource blocks to be provided in a set of resource blocks. Limits on the granularity of the layer pattern may be defined to obtain a balance between subframe diversity and quality of channel estimation by controlling the degree to which resource blocks can be allocated between two or more transmission layers 808 and 810.

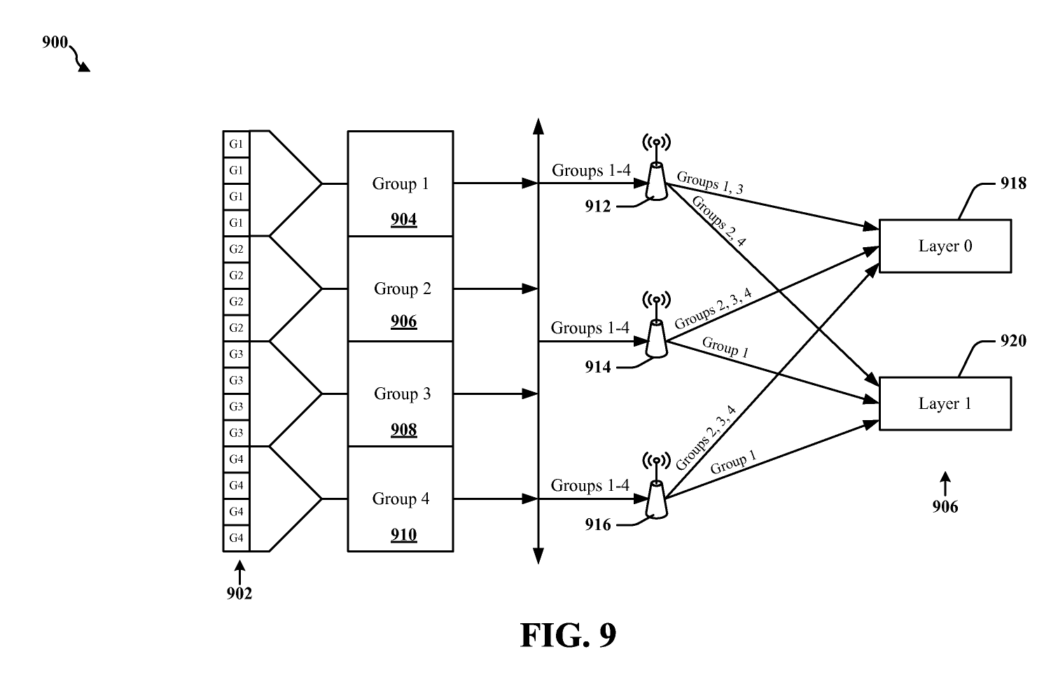

FIG. 9 illustrates a simple example 900 of resource block allocation using a portion of the resource blocks 902 in a subframe for the purpose of illustration. The resource blocks 902 may be assigned to resource block groups 904, 906, 908 and 910. Each group 904, 906, 908 and 910 comprises a plurality of the resource blocks 902. The resource blocks 902 assigned to each group 904, 906, 908 and 910 are consecutive and a minimum number of consecutive resource blocks 902 are typically assigned to each group 904, 906, 908 and 910. The resource block mapping is typically shared by all eNBs 912, 914, and 916 in an MBSFN.

Each of the groups 904, 906, 908 and 910 is transmitted by each eNB 912, 914, and 916. Each eNB 912, 914, and 916 may allocate some or all of the groups 904, 906, 908 and 910 for transmission on one or more of the available transmission layers 918 and 920. In the depicted example, one eNB 912 transmits two groups 904 and 908 in transmission layer 918 and transmits two groups 906 and 910 in transmission layer 920. Two other eNBs 914 and 916 transmit three groups 906, 908, and 910 in transmission layer 918 and transmit one group 904 in transmission layer 920. The transmission layer patterns for each eNB 912, 914 and 916 may be randomly generated by each eNB 912, 914 and 916. In some embodiments, transmission layer patterns are provided to each eNB 912, 914 and 916 in an MBSFN configuration provided, for example, by an MBSFN service provider.

Referring back to FIG. 8, a transmission layer pattern may change periodically or according to a function of time. Changes in the random layer pattern may be made for operational and other considerations, including operational characteristics of eNBs 804a and 804b, the nature of the information carried in the transmission layers 808 and 810, and other factors such as changes to the physical configuration of the MBSFN area.

The MBSFN may include cells 812 that are geographically distant from one another, and the UE 806 may receive transmissions from eNBs 804a and 804b through propagation paths that have significantly different path lengths. Differences in propagation path lengths may result in a relative delay between signals received by the UE 806 from different eNBs 804a and 804b. In order to enable a UE 806 to combine signals received with this relative delay, the MBSFN may define a cyclic prefix that accommodates differences in arrival times of signals transmitted by the eNBs 804a and 804b of the MBSFN. The cyclic prefix is typically selected to exceed the difference time between receipt of a first symbol in a transmission from an eNB 804a or 804b that has the shortest propagation path to the UE 806 and the receipt of the same first symbol from an eNB 804a or 804b that has the longest propagation path to the UE 806. When the cyclic prefix is a sufficiently long duration, data streams from all eNBs 804a and 804b may be coherently combined (herein referred to as “MBSFN gain”) and signals from eNB 804a or 804b can be received with minimal interference from the transmission from another eNB 804a or 804b.

A longer cyclic prefix may increase the number of eNBs 804a and 804b available to contributed to MBSFN gain at the UE 806 because high-powered, geographically remote eNBs 804a and 804b may contribute to MBSFN gain as seen by the UE 806. The high-powered eNBs 804a and 804b may also use omni-directional antennas for better MBSFN coverage rather than sectorized antennas, which are used in other systems to reduce interference between neighboring sectors. In eMBMS, signals from neighboring sectors of the MBSFN do not typically interfere, and may be combined to increase MBSFN gain.

UE 806 performance may be improved when the same data stream is received from a large number of eNBs 804a or 804b located in the MBSFN. Greater transmitter power and omni-directional antennas can increase the number of eNBs 804a and 804b that contribute to MBSFN gain at the UE 806 because signals from all cells can be combined coherently, and without interference, when a suitable cyclic prefix is used. In particular, the MBSFN gain at the UE 806 may be optimized when eNBs 840a and 804b use inter-site MIMO with multiple transmission layers.

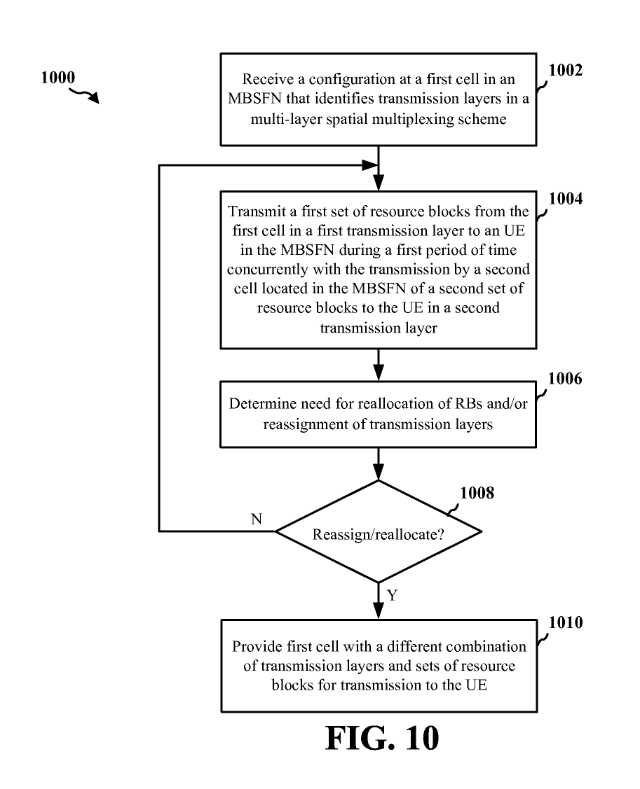

FIG. 10 is a flow chart 1000 of a method of wireless communication. The method may be performed by a first cell, e.g., eNB 804a. At step 1002, the first cell receives a configuration comprising information identifying a plurality of transmission layers (e.g., first and second transmission layers 808 and 810) in a multi-layer spatial multiplexing scheme of an MBSFN. In some embodiments, the configuration may identify groups or sets of resource blocks and assignments of resource blocks to the transmission layers 808 and 810. In some embodiments, the configuration may identify seed values for pattern generation and timing information used to change resource block allocations and assignments. In some embodiments, the configuration may define an allocation of resource blocks to each of a first set and a second set of resource blocks. In some embodiments, resource blocks are allocated to the first and second sets of resource blocks and the first and second sets of resource blocks are assigned to the first and second transmission layers 808 and 810 by an operation and maintenance service provider of the MBSFN. In some embodiments, resource blocks are allocated to the first and second sets of resource blocks and the first and second sets of resource blocks are assigned to first and second transmission layers 808 and 810 by an OAM or an MCE service provider of the MBSFN.

At step 1004, the first cell may transmit a first set of resource blocks from the first cell during a first period of time, the transmission using a first transmission layer 808 to a UE 806 located in the MBSFN. In some embodiments, at least one other cell (e.g. a second eNB 804a or 804b) located in the MBSFN concurrently transmits a second set of resource blocks to the UE 806 in a second transmission layer 810. In some embodiments, the first and second sets of resource blocks comprise the same resource blocks. In some embodiments, a plurality of cells transmit the first set of resource blocks to the UE 806 in the first transmission layer 808 during the first period of time. In some embodiments, signals from the plurality of cells arrive at the UE 806 at different times, and a cyclic prefix is defined for the MBSFN that has a duration selected to enable the UE to coherently combine the signals that arrive from the plurality of cells.

In some embodiments, the first eNB 804a transmits the first set of resource blocks in the first transmission layer 808 in accordance with an assignment of the first eNB 804a to the first transmission layer 808. In some embodiments, the assignment may be provided in the configuration. In some embodiments, the first transmission layer 808 is assigned to the first eNB 804a based on a PCI associated with the first eNB 804a. In some embodiments, the first transmission layer 808 is assigned to the first eNB 804a based on an MBSFN area identifier.

In some embodiments, the first set of resource blocks is different from the second set of resource blocks. In some embodiments, the first eNB 804a also transmits the second set of resource blocks to the UE 806 in the second transmission layer during the first period of time.

At step 1006, the first cell may determine whether to change the allocation of resource blocks to sets of resource blocks and/or to change the assignment of sets of resource blocks to transmission layers. Such determinations may be based on a current configuration or new configuration received in step 1002. In some embodiments, the first cell is reassigned to the second transmission layer 810 during a second period of time. In some embodiments, the first eNB 804a transmits resource blocks only in its currently assigned transmission layer 808 or 810. It may also be determined that the first cell is to be reassigned to a different transmission layer 810 or 808. The first eNB 804a may initiate the reassignments based on a function of time.

At step 1008, if it is determined that resource blocks do not need to reallocated and transmission layers do not require reassignment, the process returns to step 1004. If, however, resource blocks are to be reallocated or transmission layers are to be reassigned, the process proceeds to step 1010, where the first eNB 804a may perform a reconfiguration such that a data stream is transmitted during a second period time using a different combination of transmission layers and sets of resource blocks that differs from the combination used in the first period of time. For example, the first eNB may determine that resource blocks should be transmitted in the second transmission layer 810. The decision may be based on a configuration whereby the first eNB 804a transmits some resource blocks in both the first and second transmission layers 808 and 810 or based on a change in configuration that results in first eNB 804a selecting a different transmission layer 808 or 810.

In some embodiments, at least two eNBs 804a and 804b transmit the first set of resource blocks to the UE 806 in the first transmission layer during the first period of time. In some embodiments, an eNB 804a or 804b selects at least one transmission layer from a plurality of transmission layers for transmitting. One or more sets of resource blocks are transmitted in each of the plurality of transmission layers 808 and 810.

In some embodiments, the first cell transmits the first set of resource blocks in a first transmission layer 808 or 810 and a second set of resource blocks in the second transmission layer 810 or 808 based on a layer pattern provided by the configuration. In some embodiments, the first eNB 804a uses a combination of transmission layers 808 and 810 and sets of resource blocks during a second period of time that is different from the combination of transmission layers 810 and 808 and sets of resource blocks used during a first period of time.

In an aspect of the disclosure, another cell different from the first cell, such as eNB 804b, transmits at least one resource block to the UE 806 in the first transmission layer 808 during the first period of time, where the at least one resource block is not also transmitted by the first eNB 804a in the first transmission layer 808 during the first period of time. The first eNB 804a may transmit at least one resource block in the first transmission layer 808 that is also transmitted by the another eNB 804b in the first transmission layer 808 during the first period of time. The first set of resource blocks may include a group comprising minimum number of adjacent or consecutive resource blocks. The resource blocks may be grouped according to a pattern defined for the MBSFN. Transmitting a first set of resource blocks may include randomly selecting one or more resource block to be transmitted in the first transmission layer 808 and one or more resource blocks to be transmitted in the second transmission layer 810. The first cell may transmit a selection of resource blocks in the first and second transmission layers 808 and 810 during a second period of time that is different than the selection of resource blocks that is transmitted in the first and second transmission layers 808 and 810 during the first period of time.

In some embodiments, the first eNB 804a is configured to randomly select one or more sets of resource blocks for transmission. In some embodiments, the first eNB 804a transmits each randomly selected set of resource blocks in a first or second transmission layer 808 or 810 assigned by the configuration. In some embodiments, the one or more sets of resource blocks comprise resource blocks selected using a random layer pattern. In some embodiments, the random layer pattern defines a minimum number of resource blocks included in each set of resource blocks. In some embodiments, the random layer pattern defines a minimum number of adjacent resource blocks included in each set of resource blocks. In some embodiments, the random layer pattern used during the first period of time is different from a random layer pattern used during a second period of time.

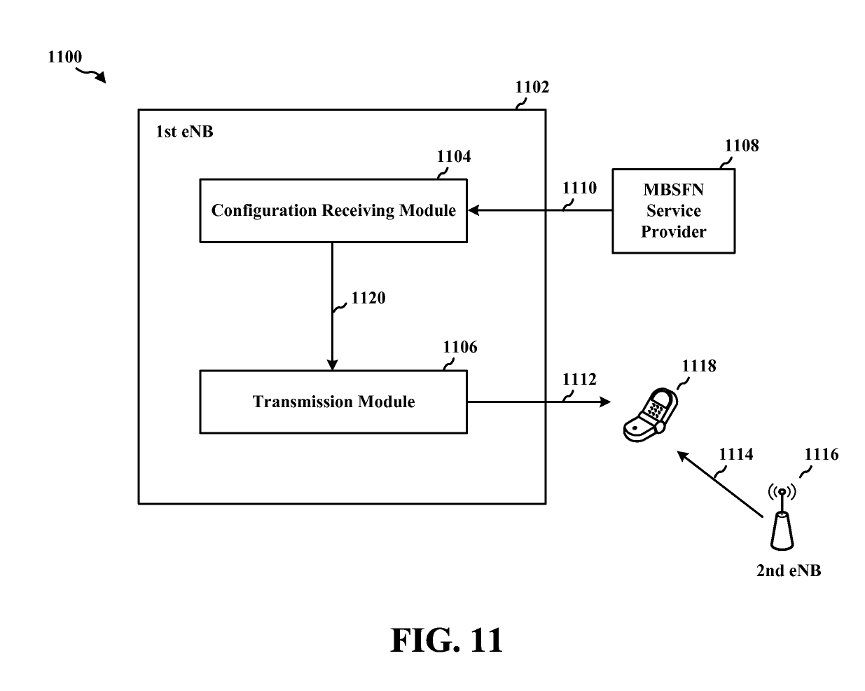

FIG. 11 is a conceptual data flow diagram 1100 illustrating the data flow between different modules/means/components in an exemplary apparatus 1102. The apparatus 1102 may be a first cell, e.g., eNB 804a, located within an MBSFN having a second cell, e.g., eNB 804b, therein. The first eNB 1102 includes a configuration receiving module 1104 that receives a signal 1110 including a configuration from, for example, a MBSFN service provider 1108. The configuration includes information identifying a plurality of transmission layers in a multi-layer spatial multiplexing scheme. The first eNB 1102 also includes a transmission module 1106 that transmits a signal 1112 including a first set of resource blocks from the first eNB during a first period of time concurrent with transmission of a signal 1114 including a second set of resource blocks from a second eNB 1116 during the first period of time. The first set of resource blocks is transmitted in a first transmission layer to an UE 1118 located in the MBSFN, and the second set of resource blocks is transmitted in a second transmission layer to the UE. The transmission module 1106 transmits resource blocks in accordance with configuration information 1120 from the configuration receiving module 1104.

The apparatus may include additional modules that perform each of the steps of the algorithm in the aforementioned flow chart of FIG. 10. As such, each step in the aforementioned flow chart of FIG. 10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

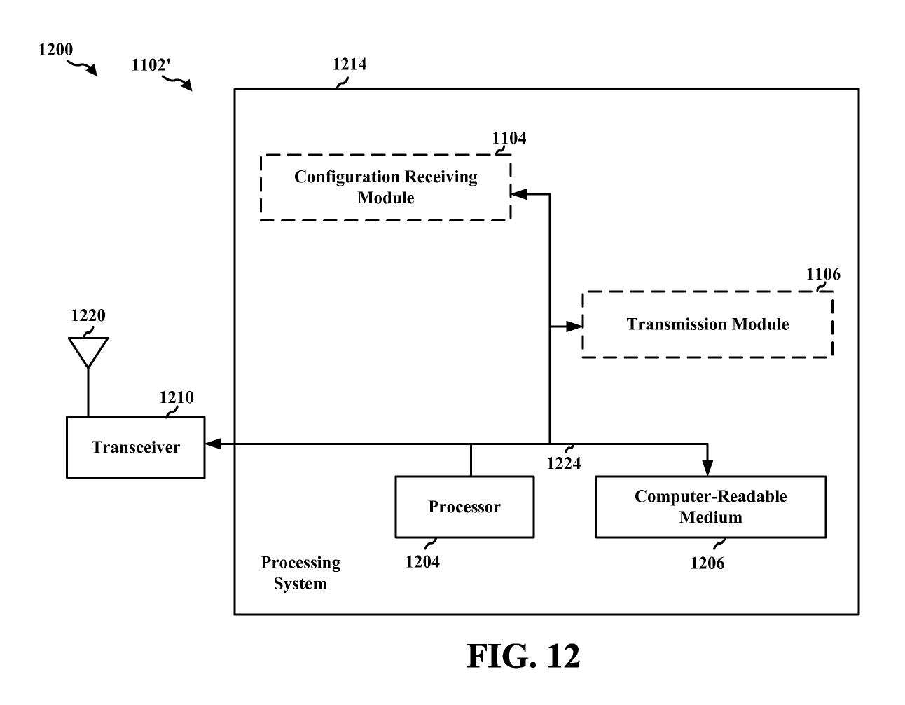

FIG. 12 is a diagram 1200 illustrating an example of a hardware implementation for an eNB 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1104, 1106 and the computer-readable medium 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the configuration receiving module 1104. In addition, the transceiver 1210 receives information from the processing system 1214, specifically the transmission module 1106, and based on the received information, generates a signal to be applied to the one or more antennas 1220. The processing system 1214 includes a processor 1204 coupled to a computer-readable medium 1206. The processor 1204 is responsible for general processing, including the execution of software stored on the computer-readable medium 1206. The software, when executed by the processor 1204, causes the processing system 1214 to perform the various functions described supra for any particular apparatus. The computer-readable medium 1206 may also be used for storing data that is manipulated by the processor 1204 when executing software. The processing system further includes at least one of the modules 1104 and 1106. The modules may be software modules running in the processor 1204, resident/stored in the computer readable medium 1206, one or more hardware modules coupled to the processor 1204, or some combination thereof. The processing system 1214 may be a component of the eNB 610 and may include the memory 676 and/or at least one of the TX processor 616, the RX processor 670, and the controller/processor 675.

In one configuration, the eNB 1102/1102′ includes means for receiving a configuration at a first eNB 804a or 804b in a MBSFN. The configuration identifies a plurality of transmission layers 808 and 810 in a multi-layer spatial multiplexing scheme. In some embodiments, the configuration may identify resource block allocations to sets of resource blocks and assignments of sets to transmission layers 808 and 810, seed values for pattern generation, and timing information used to resource block allocation to transmission layers 808 and 810. In some embodiments, the configuration may define an allocation of resource blocks to each of a first set and a second set of resource blocks. In some embodiments, resource blocks are allocated to the first and second sets of resource blocks and the first and second sets of resource blocks are assigned to the first and second transmission layers 808 and 810 by an operation and maintenance service provider of the MBSFN. In some embodiments, resource blocks are allocated to the first and second sets of resource blocks and the first and second sets of resource blocks are assigned to first and second transmission layers 808 and 810 by an OAM or an MCE service provider of the MBSFN.

In one configuration, the eNB 1102/1102′ includes means for transmitting a first set of resource blocks from the first eNB 804a during a first period of time, the transmission using a first transmission layer 808 to a UE 806 located in the MBSFN. The means for transmitting may comprise a plurality of antennas 620, corresponding transceivers 618 and one or more TX processor 616. In some embodiments, at least one other cell, e.g., eNB 804b, located in the MBSFN concurrently transmits a second set of resource blocks to the UE 806 in a second transmission layer 810. In some embodiments, the first and second sets of resource blocks comprise the same resource blocks. In some embodiments, a plurality of first cells transmit the first set of resource blocks to the UE 806 in the first transmission layer 808 during the first period of time. In some embodiments, signals from the plurality of first cells arrive at the UE 806 at different times, and a cyclic prefix is defined for the MBSFN that has a duration selected to enable the UE to coherently combine the signals that arrive from the plurality of eNBs 804a.

In some embodiments, the first cell may transmit the first set of resource blocks in the first transmission layer 808 using the means for transmitting and in accordance with an assignment of the first cell to the first transmission layer 808, the assignment being provided by the configuration. In some embodiments, the first transmission layer 808 is assigned to the first cell based on a PCI associated with the first cell. In some embodiments, the first transmission layer 808 is assigned to the first cell based on an MBSFN area identifier. In some embodiments, the first set of resource blocks is different from the second set of resource blocks. In one configuration, the means for transmitting is configured to transmit the second set of resource blocks to the UE 806 in the second transmission layer during the first period of time.

The means for receiving a configuration may determine whether to change configuration or adopt a new configuration that changes the allocation of resource blocks to sets of resource blocks and/or changes the assignment of sets of resource blocks to transmission layers. In some embodiments, the first cell is reassigned to the second transmission layer 810 during a second period of time. In some embodiments, the first cell transmits resource blocks only in its currently assigned transmission layer 808 or 810. In some embodiments, the means for receiving a configuration determines that the first cell should be reassigned to the second transmission layer 810. The reassignment may be initiated based on a function of time. The first and second eNBs 804a and 804b may be reconfigured to transmit a data stream in a second period time using a different combination of transmission layers and sets of resource blocks that is different than the combination used in the first period of time. Reassignment of the first and second transmission layers 808 and 810 may include changing assigning certain antenna of the plurality of antennas 620 to obtain a desired spatial coding of the signals transmitted by the first cell and/or the second cell 804b.

Optionally, the means for receiving a configuration may determine whether the first eNB 804a is to transmit resource blocks in the second transmission layer 810. The decision may be based on a configuration whereby the first eNB 804a transmits some resource blocks in both the first and second transmission layers 808 and 810 or based on a change in configuration that results in first eNB 804a selecting a different transmission layer 808 or 810.

In some embodiments, the first cell transmits the first set of resource blocks in a first transmission layer 808 and a second set of resource blocks in the second transmission layer 810 based on a layer pattern provided by the configuration. In some embodiments, the first cell uses a combination of first and second transmission layers 808 and 810 and sets of resource blocks during a second period of time that is different from the combination of first and second transmission layers 810 and 808 and sets of resource blocks used during a first period of time.

Referring again to FIG. 9, in some embodiments, a first eNB 912 is configured to randomly select between one or more transmission layers 918 and 920 for transmitting each of one or more resource block groups 904, 906, 908, and 910. Other eNBs 914 and 916 may transmit different combinations of groups 904, 906, 908, and 910 in the one or more transmission layers 918 and 920. In some embodiments, each eNB 912, 914, and 916 transmits all resource block groups 904, 906, 908, and 910. In some embodiments, resource block groups 904, 906, 908, and 910 are assigned to transmission layers 918 and 920 by the configuration. In some embodiments, the resource block groups 904, 906, 908, and 910 are allocated for transmission in the one or more transmission layers 918 and 920 using a random layer pattern. The random layer patter may be defined by the MNSFN and may be common to all 912, 914, and 916 in the MBSFN. In some embodiments, the random layer pattern defines a minimum number of resource blocks included in each set of resource blocks. In some embodiments, the random layer pattern defines a minimum number of adjacent or consecutive resource blocks included in each set of resource blocks. In some embodiments, the random layer pattern used during the first period of time is different from a random layer pattern used during a second period of time.

Referring again to FIG. 8, in some embodiments, the means for transmitting may cause another cell, e.g., 804b, to transmit at least one resource block to the UE 806 in the first transmission layer 808 during the first period of time, where the at least one resource block is not also transmitted by the first eNB 804a in the first transmission layer 808 during the first period of time. Alternatively, the first eNB 804a may transmit at least one resource block in the first transmission layer 808 that is also transmitted by the another eNB 804b in the first transmission layer 808 during the first period of time. The first set of resource blocks may include a minimum number of adjacent resource blocks. Transmitting a first set of resource blocks may include randomly selecting one or more resource block to be transmitted in the first transmission layer 808 and one or more resource blocks to be transmitted in the second transmission layer 810. The first eNB 804a may transmit a selection of resource blocks in the first and second transmission layers 808 and 810 during a second period of time that is different than the selection of resource blocks that is transmitted in the first and second transmission layers 808 and 810 during the first period of time.

Each of the aforementioned means may be one or more of the aforementioned modules 1104 and 1106 of the apparatus 1102 and/or the processing system 1214 of the apparatus 1102 configured to perform the functions recited by the aforementioned means. As described supra, the processing system 1214 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving a configuration at a first cell in a Media Broadcast over a Single Frequency Network (MBSFN), the configuration including information identifying a plurality of transmission layers in a multi-layer spatial multiplexing scheme; and
during a first period of time, transmitting a first set of resource blocks from the first cell in a first transmission layer to an user equipment (UE) located in the MBSFN,
wherein a second cell located in the MBSFN concurrently transmits a second set of resource blocks to the UE in a second transmission layer during the first period of time.

2. The method of claim 1, wherein the first and second sets of resource blocks comprise the same resource blocks.

3. The method of claim 1, wherein a plurality of cells transmit the first set of resource blocks to the UE in the first transmission layer during the first period of time.

4. The method of claim 3, wherein signals from the plurality of cells arrive at the UE at different times, and wherein a cyclic prefix is defined for the MBSFN that has a duration selected to enable the UE to coherently combine the signals that arrive from the plurality of cells.

5. The method of claim 1, wherein the first cell transmits the first set of resource blocks in the first transmission layer in accordance with an assignment of the first cell to the first transmission layer, the assignment being provided by the configuration.

6. The method of claim 5, wherein the first transmission layer is assigned to the first cell based on a physical cell identifier (PCI) associated with the first cell.

7. The method of claim 5, wherein the first transmission layer is assigned to the first cell based on an MBSFN area identifier.

8. The method of claim 5, wherein the first cell is reassigned to the second transmission layer during a second period of time and wherein the first cell transmits resource blocks only in its currently assigned transmission layer.

9. The method of claim 8, wherein reassignment of the first cell to the second transmission layer is initiated based on a function of time.

10. The method of claim 1, wherein the first set of resource blocks is different from the second set of resource blocks.

11. The method of claim 10, wherein the first cell transmits the second set of resource blocks to the UE in the second transmission layer during the first period of time.

12. The method of claim 11, wherein the configuration defines an allocation of resource blocks to each of the first and second sets of resource blocks.

13. The method of claim 11, wherein the first cell transmits the first set of resource blocks in the first transmission layer and the second set of resource blocks in the second transmission layer based on a layer pattern provided by the configuration.

14. The method of claim 10, wherein the first cell transmits during a second period of time using a combination of transmission layers and sets of resource blocks that is different from the combination of transmission layers and sets of resource blocks used during the first period of time.

15. The method of claim 1, wherein during the first period of time, another cell transmits at least one resource block to the UE in the first transmission layer that is not also transmitted by the first cell in the first transmission layer during the first period of time.

16. The method of claim 15, wherein the first cell transmits at least one resource block in the first transmission layer that is also transmitted by the another cell in the first transmission layer during the first period of time.

17. The method of claim 15, wherein the first set of resource blocks includes a minimum number of adjacent resource blocks.

18. The method of claim 15, wherein transmitting a first set of resource blocks includes randomly selecting a group of resource blocks to be transmitted in the first transmission layer and a group of resource blocks to be transmitted in the second transmission layer.

19. The method of claim 18, wherein the first cell transmits a selection of resource blocks in the first and second transmission layers during a second period of time that is different than the selection of resource blocks that is transmitted in the first and second transmission layers during the first period of time.

20. The method of claim 18, wherein the randomly selected group of resource blocks is a function of a physical cell ID (PCI).

21. The method of claim 1, wherein resource blocks are allocated to the first and second sets of resource blocks and the first and second sets of resource blocks are assigned to the first and second transmission layers by an operation and maintenance service provider of the MBSFN.

22. The method of claim 1, wherein resource blocks are allocated to the first and second sets of resource blocks and the first and second sets of resource blocks are assigned to the first and second transmission layers by a Multi-Cell/Multicast Coordination Entity (MCE) of the MBSFN.

23. A first cell for wireless communication in a Media Broadcast over a Single Frequency Network (MBSFN) having a second cell therein, said first cell comprising:
means for receiving a configuration including information identifying a plurality of transmission layers in a multi-layer spatial multiplexing scheme; and
means for transmitting a first set of resource blocks during a first period of time concurrent with transmission of a second set of resource blocks from the second cell during the first period of time, wherein the first set of resource blocks is transmitted in a first transmission layer to an user equipment (UE) located in the MBSFN, and the second set of resource blocks is transmitted in a second transmission layer to the UE.

24. The first cell of claim 23, wherein the first and second sets of resource blocks comprise the same resource blocks.

25. The first cell of claim 23, wherein the configuration includes information defining an assignment of the first cell to the first transmission layer, and the means for transmitting is configured to transmit the first set of resource blocks in the first transmission layer in accordance with the assignment.

26. The first cell of claim 25, wherein the assignment is based on a physical cell identifier (PCI) associated with the first cell.

27. The first cell of claim 25, wherein the assignment is based on an MBSFN area identifier.

28. The first cell of claim 25, wherein the configuration includes information defining a reassignment of the first cell to the second transmission layer during a second period of time, and the means for transmitting is configured to transmit resource blocks only in the currently assigned transmission layer.

29. The first cell of claim 28, wherein reassignment of the first cell to the second transmission layer is initiated based on a function of time.

30. The first cell of claim 23, wherein the first set of resource blocks is different from the second set of resource blocks.

31. The first cell of claim 30, wherein the means for transmitting is configured to transmit the second set of resource blocks to the UE in the second transmission layer during the first period of time.

32. The first cell of claim 31, wherein the configuration defines an allocation of resource blocks to each of the first and second sets of resource blocks.

33. The first cell of claim 31, wherein the configuration provides a layer pattern assigning the first set of resource blocks in the first transmission layer and the second set of resource blocks in the second transmission layer, and the means for transmitting is configured to transmit based on the layer pattern.

34. The first cell of claim 30, wherein the means for transmitting is configured to transmit during a second period of time using a combination of transmission layers and sets of resource blocks that is different from the combination of transmission layers and sets of resource blocks used during the first period of time.

35. The first cell of claim 23, wherein during the first period of time, another cell transmits at least one resource block to the UE in the first transmission layer that is not also transmitted by the first cell in the first transmission layer during the first period of time.

36. The first cell of claim 35, wherein the means for transmitting is configured to transmits at least one resource block in the first transmission layer that is also transmitted by the another cell in the first transmission layer during the first period of time.

37. The first cell of claim 35, wherein the first set of resource blocks includes a minimum number of adjacent resource blocks.

38. The first cell of claim 35, wherein the means for transmitting is configured to randomly select one or more resource blocks to be transmitted in the first transmission layer and one or more resource blocks to be transmitted in the second transmission layer.

39. The first cell of claim 38, wherein the means for transmitting is configured to transmit a selection of resource blocks in the first and second transmission layers during a second period of time that is different than the selection of resource blocks that is transmitted in the first and second transmission layers during the first period of time.

40. The method of claim 38, wherein the randomly selected group of resource blocks is a function of a physical cell ID (PCI).

41. The first cell of claim 23, wherein the configuration includes information allocating resource blocks to the first and second sets of resource blocks and assigning the first and second sets of resource blocks to the first and second transmission layers.

42. The first cell of claim 40, wherein the configuration is provided by one of an operation and maintenance service provider of the MBSFN or a Multi-Cell/Multicast Coordination Entity (MCE) of the MBSFN.

43. A first cell in a Media Broadcast over a Single Frequency Network (MBSFN) having a second cell therein, said first cell comprising:
a processing system configured to:
receive a configuration including information identifying a plurality of transmission layers in a multi-layer spatial multiplexing scheme; and
transmit a first set of resource blocks during a first period of time concurrent with transmission of a second set of resource blocks from the second cell during the first period of time, wherein the first set of resource blocks is transmitted in a first transmission layer to an user equipment (UE) located in the MBSFN, and the second set of resource blocks is transmitted in a second transmission layer to the UE.

44. A computer program product for a first cell in a Media Broadcast over a Single Frequency Network (MBSFN) having a second cell therein, said product comprising, comprising:
a computer-readable medium comprising code for:
receiving a configuration including information identifying a plurality of transmission layers in a multi-layer spatial multiplexing scheme; and
transmitting a first set of resource blocks from the cell during a first period of time concurrent with transmission of a second set of resource blocks from the second cell during the first period of time, wherein the first set of resource blocks is transmitted in a first transmission layer to an user equipment (UE) located in the MBSFN, and the second set of resource blocks is transmitted in a second transmission layer to the UE.
